(19) United States
(12) Patent Application Publication
(10) Pub. No.: US 2009/0207129 A1
(43) Pub. Date: Aug. 20, 2009

(54) Providing Haptic Feedback To User-Operated Switch

(75) Inventors: Christopher J. Ullrich, Ventura, CA (US); Stephen Kingsley-Jones, Santa Cruz, CA (US); Michael Levin, Los Altos, CA (US)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignee: Immersion Corporation, San Jose, CA (US)

(21) Appl. No.: 12/031,984

(22) Filed: Feb. 15, 2008

(51) Int. Cl. G09G 5/00

(52) U.S. Cl. 345/156

(57) ABSTRACT

Systems and methods are disclosed herein for generating haptic feedback, tactile feedback, or force feedback to an electromechanical switch that is toggled by a user. In one specific example among many possible embodiments, a switch feedback system is disclosed. The switch feedback system comprises a user-operated switch, which is operable to toggle between one of an open state and a closed state. The switch feedback system also includes electrical circuitry in electrical communication with the user-operated switch, wherein the electrical circuitry is configured to react to a change of state of the user-operated switch. The system also includes a haptic feedback device in electrical communication with the user-operated switch and in physical communication with the user-operated switch. The haptic feedback device is configured to detect the change of state of the user-operated switch and provide a haptic feedback to the user-operated switch in response to the detected change of state.

### TECHNICAL FIELD

The present disclosure generally relates to switches that can be manually toggled between an open state and a closed state. More particularly, the present disclosure relates to systems and methods for providing haptic feedback to such switches.

### BACKGROUND

Electromechanical switches are common in electrical circuits for enabling a user to control certain aspects of a circuit. In general, an electromechanical switch includes a mechanical component that is operated by a user. The mechanical component is typically configured to move an electrical component that can either make or break an electrical connection between two metal contacts. Some examples of electromechanical switches include toggle switches, in-line switches, push-button switches, rocker switches, keypad switches, etc. These and other types of switches are encountered in everyday life and find application as light switches mounted on a wall, elevator buttons, lamp switches, telephone buttons, etc.

As the design of many electronic devices has miniaturized in recent years, newer types of switches have been developed. For example, handheld electronic devices, such as video game devices, smart phones, personal digital assistants (PDAs), etc., often include arrays of small push-button switches for allowing user entry. In many applications, snap dome switches are used to provide a tactile “snap” sensation to the user when a button is pressed. This sensation gives the user a type of confirmation that the entry has been received. However, in other applications, such as touch screens and in some handheld devices, the screens or buttons might be designed without the provision of tactile sensations for the user. Unfortunately, it might be difficult for a user to know when an entry is actually received and may have to press or touch the screen repeatedly to successfully make an entry.

### SUMMARY

The present disclosure describes systems and methods for providing haptic feedback to a user-operated switch. In one of several possible embodiments disclosed herein, a switch feedback system comprises a user-operated switch operable to toggle between one of an open state and a closed state. The system also comprises electrical circuitry in electrical communication with the user-operated switch. The electrical circuitry is configured to react to a change of state of the user-operated switch. The system also comprises a haptic feedback device in electrical communication with the user-operated switch and in physical communication with the user-operated switch. The haptic feedback device is configured to detect the change of state of the user-operated switch and provide a haptic feedback to the user-operated switch in response to the detected change of state.

Other features, advantages, and implementations of the present disclosure, not expressly disclosed herein, will be apparent to one of ordinary skill in the art upon examination of the following detailed description and accompanying drawings. It is intended that such implied implementations of the present disclosure be included herein.

### BRIEF DESCRIPTION OF THE DRAWINGS

The components in the following figures are not necessarily drawn to scale. Instead, emphasis is placed upon clearly illustrating the general principles of the present disclosure. Reference characters designating corresponding components are repeated as necessary throughout the figures for the sake of consistency and clarity.

FIG. 1 is a block diagram illustrating a switch feedback system according to one embodiment.

FIG. 2 is a block diagram illustrating the haptic feedback device shown in FIG. 1 according to one embodiment.

FIG. 3 is a diagram illustrating an example of a mechanical coupling between a switch and an actuator according to one embodiment.

FIG. 4 is a flow chart illustrating a method for providing a haptic feedback sensation to a switch according to one embodiment.

### DETAILED DESCRIPTION

Although various electronic devices normally include different types of buttons and/or switches for allowing a user to enter information, many buttons and switches are not particularly user-friendly. For data entry, some electronic devices include touch screens, which include display devices that can display a number of options selectable by the user. These touch screens are sensitive to a pressure applied to the screen, which is received as a selection of one of the options. However, since a user might not be aware of the touch sensitivity of the screen, an attempt to enter information may not be registered.

In other applications, handheld devices often include an array of buttons and/or switches having a small form factor. Many of these devices are designed without the same mechanical feel as a switch or button that might be normally encountered on a larger scale. Electromechanical switches normally include a mechanical component having click-stops, mechanical resistance, or other sensation for verifying to the user that the entry has been received. Because of the difficulty of using these switches and buttons without the benefit of the knowledge of the switch's sensitivity to touch, a user may have to press a button more than once to enter the desired input.

The present application discloses systems and methods for overcoming these deficiencies by providing haptic feedback to a switch that is being operated by a user. Haptics can be used to provide feedback when the user manually changes the state of the switch. Haptics can also be used to indicate when the switch is active or inactive. In still other applications, haptics can be used to convey when a value or function is being changed within minimum and maximum limits.

Inevitably, a delay will be experienced between the actual switching of the switch and the time at which the change of switch state is processed to create haptic feedback. However, the present disclosure describes systems that can have such a short delay that the sensation of the feedback can be felt by the user while the user is still touching the button or switch. Feedback provided within a very short delay, such as on the order of about 25-30 ms, is normally perceived as occurring simultaneously with the actually physical action of toggling a switch. Within such a short delay, the user would typically still be in physical contact with the switch to be able to sense the feedback. The following description includes operable embodiments and implementations for providing haptic feedback to user-operated switches.

FIG. 1 is a block diagram showing an embodiment of a switch feedback system 10, which is configured to provide haptic or tactile sensations to a switch. In this embodiment, switch feedback system 10 includes a user-operated switch 12, electrical circuitry 14, and a haptic feedback device 16. User-operated switch 12, for example, may be a mechanical switch, an electrical switch, an electro-mechanical switch, or other suitable type of switch. Some examples of mechanical switches include compressible buttons, keys on a keyboard or keypad, momentary (normally-open or normally-closed) switches, toggle switches, etc. In other embodiments, user-operated switch 12 may be a membrane switch. Other examples of user-operated switch 12 may include a device that is part of a touchscreen device or other interactive display device having an output display incorporated with touch-responsive input mechanisms.

A user operates user-operated switch 12 by contacting, such as with a finger, a mechanical portion of user-operated switch 12. The user's contact may be in the form of a compression force, such as is typically used with a button or key, or a lateral force, such as is typically used with a toggle switch. Furthermore, user-operated switch 12 may include a sensor for sensing a change in resistance or capacitance based on contact of a user's finger with the sensor. Also, measurements of heat from a user's finger can be sensed by a switch. User-operated switch 12 may include these or other suitable characteristics for sensing when a user turns a switch on or off.

As a result of user activation, user-operated switch 12 can change states. For example, user-operated switch 12 may be in an “open” state, which corresponds to an electrically non-conductive condition. On the other hand, user-operated switch 12 may be in a “closed” state, which corresponds to an electrically conductive condition. In some embodiments, user-operated switch 12 may be configured as a momentary switch. In this case, the user temporarily changes the state of the switch until the user releases pressure on the switch, at which point the switch returns to its normal state. In other implementations, user-operated switch 12 can be a multi-state switch capable of one or several possible configurations.

In a typical fashion, user-operated switch 12 controls the flow of current to electrical circuitry 14. Electrical circuitry 14 may represent any suitable electronic device or circuit in which one or more switches can be manually toggled from one state to another or momentarily switched to another state. In this regard, electrical circuitry 14 may be any regular or normal circuit. The changes in the state of user-operated switch 12 control electrical circuitry 14 in a binary manner—conducting or non-conducting.

In addition to the regular components of the embodiment of FIG. 1, switch feedback system 10 also includes haptic feedback device 16, which is connected to user-operated switch 12. For example, haptic feedback device 16 may be connected in parallel with electrical circuitry 14. In other embodiments, haptic feedback device 16 may be connected to a different portion of user-operated switch 12 to detect when the switch changes state with respect to electrical circuitry 14. Haptic feedback device 16 may also be connected upstream of electrical circuitry 14 and may respond according to some system state, network event, etc., in electrical circuitry 14 or other related circuitry.

In response to detecting when user-operated switch 12 changes states, haptic feedback device 16 provides a haptic or tactile sensation to user-operated switch 12. Thus, a user touching user-operated switch 12 can feel the sensation generated by haptic feedback device 16. Also, the haptic sensation can be provided with very little delay from the time that user-operated switch 12 changes states in order that the sensation can be felt by the user while contacting user-operated switch 12. In particular, haptic feedback device 16 may be capable of providing a haptic sensation in as little as about 10 ms from the time that the user changes the state of user-operated switch 12.

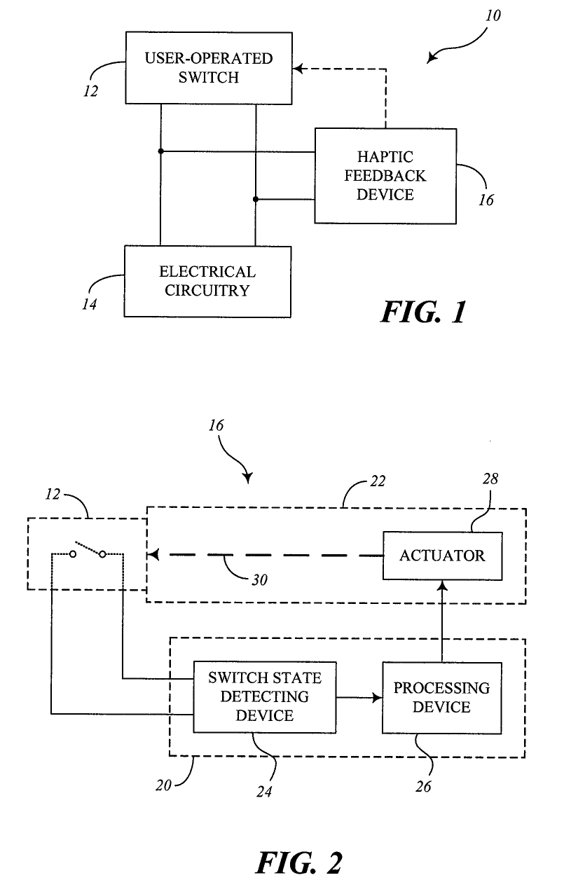

FIG. 2 is a block diagram showing an embodiment of haptic feedback device 16 shown in FIG. 1 with reference to at least a portion of user-operated switch 12. In this embodiment, haptic feedback device 16 generally includes an electrical interface 20 and a mechanical interface 22. Electrical interface 20 may include, for example, a switch state detecting device 24 and a processing device 26. In other embodiments, electrical interface 20 may be configured using a different combination of components that are capable of sensing when a switch changes states and providing a control signal to a mechanism for providing haptic sensations to any type of switching device. Mechanical interface 22 in this embodiment includes an actuator 28 and a mechanical coupling 30. Although mechanical coupling 30 is shown in phantom in FIG. 2, it should be understood that mechanical coupling 30 may include any suitable physical structure for translating physical forces from actuator 28 to a portion of the body of user-operated switch 12. In particular, mechanical coupling 30 may supply force to the entire user-operated switch 12 or instead focused on a portion of the switch.

User-operated switch 12, as shown in FIG. 2, is represented schematically. However, it should be understood that user-operated switch 12 may include other switching mechanism or circuits, such as transistor-based components, which may be represented using other schematic symbols. Also, the portion of user-operated switch 12, as shown, can include a portion that does not include the actual switching mechanism that electrically makes or breaks the current flow. In addition, mechanical coupling 30 may apply force from actuator 28 to any suitable portion of user-operated switch 12 and which does not necessarily include the portion used to detecting the state of the switch.

Switch state detecting device 24 basically detects when the state of user-operated switch 12 changes from one state to another, namely, from open to closed or from closed to open. Switch state detecting device 24 may include any suitable electrical or logic sensing components for detecting this state transition. In response to a detected state change, switch state detecting device 24 sends an indication signal to processing device 26 indicating either the fact that the state of the switch has changed or the current open or closed state of the switch.

Processing device 26 is configured to process the indication signal from switch state detecting device 24. Depending on the type of user-operated switch 12 being used, processing device 26 determines whether or not actuator 28 should be actuated to provide a haptic sensation to the switch. Processing device 26 also determines what type of haptic sensation actuator 28 should apply to the switch. For instance, based on certain predetermined factors with respect to toggling the state of a switch, processing device 26 may instruct actuator 28 to provide any number of different types of sensations. By indicating a frequency or amplitude of an oscillation, for example, processing device 26 can simulate different sensations. In some embodiments, processing device 26 may include preset responses to certain switch state conditions. In other embodiments, processing device 26 can be programmed to create a unique correlation between switching states and haptic responses.

Actuator 28 may be configured as or associated with any suitable type of device capable of receiving one or more electrical signals and generating any type of mechanical movement, such as, for example, a linear resonating actuator (LRA), piezo actuator, electroactive polymer, shape memory alloy, etc. Actuator 28 may provide an oscillation, vibration, vibrotactile sensation, etc. for providing a physical force. In some embodiments, actuator 28 may include a rotary component having an eccentric center of gravity rotatable around an axis.

The force generated by actuator 28 is translated via mechanical coupling 30 to user-operated switch 12. In some embodiments, actuator 28 may be mechanically coupled to multiple switches, and in other embodiments, more than one actuator 28 may be mechanically coupled to one switch. Mechanical coupling 30 may include any type or combination of printed circuit boards, supports, arms, pivoting members, gears, or other suitable force conveying devices to efficiently supply forces to user-operated switch 12.

Processing device 26 may be a general-purpose or specific-purpose processor or microcontroller and may execute software stored on an accessible memory, which may include internally fixed storage and/or removable storage media for storing information, data, and/or instructions. The storage within the memory components may include any combination of volatile memory and/or non-volatile memory for storing a software program that enables processing device 26 to execute procedures for matching certain switch conditions with appropriate haptic feedback responses. These procedures or executable logical instructions can be embodied in any suitable computer-readable medium for execution by processing device 26. The computer-readable medium, as described herein, can include any physical medium that can store the programs or software code for a measurable length of time.

Various logical instructions may be included in processing device 26 or related memory. Portions or all of processing device 26 can be implemented in hardware, software, firmware, or a combination thereof. When implemented in hardware, the logical instructions can be implemented, for example, using discrete logic circuitry, an application specific integrated circuit (ASIC), a programmable gate array (PGA), a field programmable gate array (FPGA), etc., or any combination thereof.

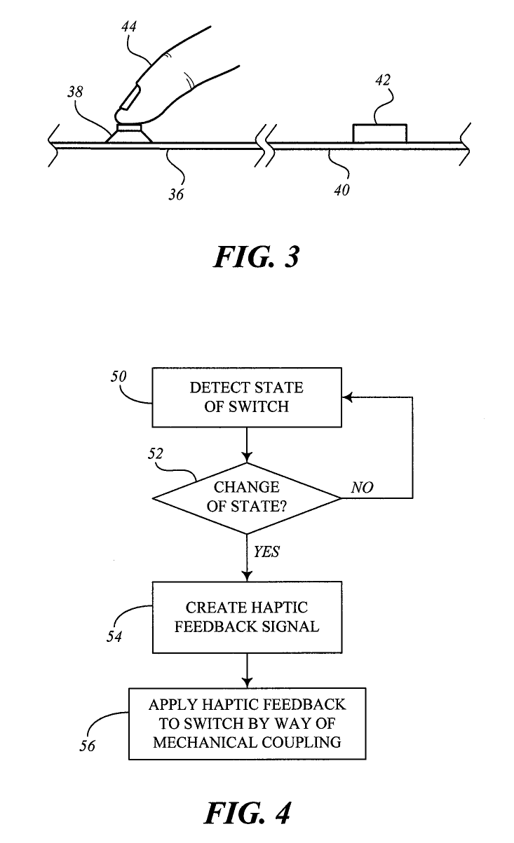

FIG. 3 is a diagram showing an embodiment of a switch mechanically coupled to an actuator. In this example, a first printed circuit board 36 supports a switch 38 and a second printed circuit board 40 supports an actuator 42. FIG. 3 also illustrates a finger of a user 44 operating switch 38. User 44 contacts switch 38 and applies a pressure to a portion of switch 38, causing switch 38 to change states. In some embodiments, switch 38 may be a normally open switch, such as a snap dome switch that snaps to a closed or conducting state when a metal portion of the snap dome is deformed to an inverted orientation. The snapping sensation of such a switch can be sensed by user 44 when the metal portion is compressed beyond its stable threshold level. When pressure is released, the metal portion snaps back to its normal shape, thereby opening switch 38 and creating a non-conducting state.

While user 44 is pressing switch 38, the change in state of the switch can be detected. In response to detecting the change of state, a signal is sent to actuator 42 prompting actuator 42 to provide a haptic sensation to switch 38 itself. The mechanical force of the movement or oscillation of actuator 42 is conveyed via second printed circuit board 40 to first printed circuit board 36. Since switch 38 is mounted on first printed circuit board 36, switch 38 experiences the force that is applied to first printed circuit board 36. Naturally, there is a delay from the time at which the state of switch 38 changes to the time at which switch 38 experiences the mechanical force. This delay can be kept to a minimum such that user 44 is able to sense the physical movement of switch 38 while pressing switch 38. Also, by reducing this delay, actuator 42 can provide a sensation to user 44 that more clearly communicates that the sensation is related to the pressing of switch 38. For example, a human normally disassociates the two events when they are separated by at least 35 ms. The embodiments of the present disclosure can provide a sensation in about 10-30 ms, thereby allowing user 44 to perceive that the pressing of switch 38 and the haptic sensation are related.

In some embodiments, first printed circuit board 36 and second printed circuit board 40 are separate boards that are connected by any suitable mechanical coupling. In other embodiments, first printed circuit board 36 and second printed circuit board 40 are the same board.

FIG. 4 is a flow chart showing an embodiment of a method for providing a haptic sensation to a user who is operating a switch. In block 50, the state of a switch, i.e. open or closed, is detected. In decision block 52, it is determined whether or not there has been a change in the state of the switch. If no change is detected, then the method loops back to block 50 to detect the state of the switch until a change occurs. When a change in state is determined in block 52, the method proceeds to block 54, which indicates that a haptic feedback signal is created. The creation of the haptic feedback signal can be directly dependent upon the condition of the change of state of the switch as determined in blocks 50 and 52. The haptic feedback signal is supplied to a suitable device, and as indicated in block 56 a haptic feedback is applied to the switch by way of a mechanical coupling.

The method of FIG. 4 include two primary interactions with a switch used in an electrical device. The first interaction is the electrical detection of an electrically conductive state of the switch. In a conductive state, the switch is referred to as being in a closed condition or state. In a non-conductive state, the switch is referred to as being in an open condition or state. The second interaction with the switch involves the mechanical movement of the switch by a physical motion. Based on the change in state of the switch, the force feedback system described herein supplies a force to the switch that can be sensed by a user in contact with the switch. Because of the low latency of the processing, the force feedback system can supply the force while the user is still in contact with the switch and could therefore sense the mechanical force.

It should be understood that the steps, processes, or operations described herein may represent any module or code sequence that can be implemented in software or firmware. In this regard, these modules and code sequences can include commands or instructions for executing specific logical steps, processes, or operations within physical components. It should further be understood that one or more of the steps, processes, and/or operations described herein may be executed substantially simultaneously or in a different order than explicitly described, as would be understood by one of ordinary skill in the art.

The embodiments described herein merely represent examples of implementations and are not intended to necessarily limit the present disclosure to any specific embodiments. Instead, various modifications can be made to these embodiments as would be understood by one of ordinary skill in the art. Any such modifications are intended to be included within the spirit and scope of the present disclosure and protected by the following claims.

We claim:

1. A switch feedback system comprising:
a user-operated switch configured to switch between at least two states;
circuitry in electrical communication with the user-operated switch, the circuitry configured to react to a change of state of the user-operated switch; and
a haptic feedback device in electrical communication with the user-operated switch and in mechanical communication with the user-operated switch;
wherein the haptic feedback device is configured to detect the change of state of the user-operated switch and provide a haptic feedback to the user-operated switch in response to the detected change of state.

2. The switch feedback system of claim 1, wherein the user-operated switch and haptic feedback device are physically separated from each other.

3. The switch feedback system of claim 1, wherein the user-operated switch is a multi-state switch configured to switch among a plurality of states.

4. The switch feedback system of claim 1, wherein the electrical circuitry and the haptic feedback device are electrically in parallel with each other.

5. The switch feedback system of claim 1, wherein the user-operated switch comprises a first contact mechanism and a second contact mechanism, the first contact mechanism and the second contact mechanism being electrically isolated from each other, the first contact mechanism being in electrical communication with the electrical circuitry and the second contact mechanism being in electrical communication with the haptic feedback device.

6. The switch feedback system of claim 1, wherein the user-operated switch is a mechanical switch.

7. The switch feedback system of claim 1, wherein the user-operated switch is a membrane switch.

8. The switch feedback system of claim 1, wherein the user-operated switch is part of a touch-screen device.

9. The switch feedback system of claim 1, wherein the user-operated switch is a momentary switch.

10. The switch feedback system of claim 1, wherein the haptic feedback device is in electrical communication with a plurality of user-operated switches and is in mechanical communication with the plurality of user-operated switches, and wherein the haptic feedback device is configured to provide haptic feedback to the plurality of user-operated switch in response to detecting a change of state of one of the plurality of user-operated switches.

11. A haptic feedback device comprising:
an electrical interface configured in electrical communication with a switch, the electrical interface comprising means for detecting a conductive state of the switch; and
a mechanical interface configured in electrical communication with the electrical interface and in mechanical communication with the switch, the mechanical interface comprising means for mechanically coupling with the switch and means for actuating movement of the mechanically coupling means;
wherein the mechanical interface is configured to apply a force to at least a portion of the switch based on the conductive state of the switch.

12. The haptic feedback device of claim 11, wherein the means for detecting the conductive state of the switch determines when the conductive state changes from a conductive state to a non-conductive state or from a non-conductive state to a conductive state.

13. The haptic feedback device of claim 11, wherein the switch is a normally-open switch and the means for detecting the conductive state of the switch determines when the normally-open switch is closed.

14. The haptic feedback device of claim 11, wherein the electrical interface further comprises means for processing information related to the conductive state of the switch.

15. The haptic feedback device of claim 11, wherein the actuating means provides a vibrotactile effect.

16. The haptic feedback device of claim 11, wherein the means for mechanically coupling comprises a printed circuit board.

17. The haptic feedback device of claim 16, wherein the switch and the actuating means are mounted on the printed circuit board.

18. A method comprising:
detecting a state of an electromechanical switch;
determining a change in the state of the electromechanical switch; and
applying a physical force to the electromechanical switch by way of a mechanical coupling.

19. The method of claim 18, wherein applying the physical force further comprises:
creating a haptic feedback signal when a change in state occurs; and
applying a haptic feedback in response to the haptic feedback signal.

20. The method of claim 18, wherein the electromechanical switch is a normally-open switch, and wherein detecting the state of the electromechanical switch and determining a change in the state of the electromechanical switch comprises:
determining when the normally-open switch is closed.

21. The method of claim 18, wherein the physical force is sufficient to be sensed by a user in contact with a portion of the electromechanical switch.

22. The method of claim 18, wherein the physical force is applied with a latency of 30 ms or less from the time when the change in state is determined.

23. The method of claim 22, wherein the latency is approximately 10 ms.
